(19) United States
(12) Patent Application Publication
(10) Pub. No.: US 2008/0248185 A1
(43) Pub. Date: Oct. 9, 2008

(54) Base Composition

(76) Inventor: Maurizio Ferrari, Pavia (IT)

Correspondence Address: DIEHL SERVILLA LLC, 77 BRANT AVE, SUITE 210, CLARK, NJ, 07066, US

(21) Appl. No.: 11/695,765

(22) Filed: Apr. 3, 2007

(51) Int. Cl. A23L 1/035; A23L 1/216; A23L 1/222; A23L 1/224

(52) U.S. Cl. 426/616; 426/615; 426/618; 426/634; 426/637

(57) ABSTRACT

Base compositions, methods of manufacturing base compositions and frozen food products including a base composition are described. According to one or more embodiments, a base composition for a frozen food product includes at least one insoluble fiber, at least one soluble fiber, at least one emulsifier and at least one stabilizer. In one or more aspects of the invention, methods are provided for processing the base composition with additional ingredients to provide flavor, sweetness and the like for a variety of frozen food products such as: frozen desserts; ice creams; gelato; and mousse, either confectionary, seafood-type or savory vegetable-type, with desirable organoleptic and stability properties. In one or more embodiments, base compositions and methods described herein are suitable for preparing many types of frozen food products ranging from dairy-type products to those having low-fat, low calorie, fruit flavors and the like.

### TECHNICAL FIELD

The present invention relates to a composition forming the base of a frozen food product and to a frozen food product made therefrom. It also relates to a process of manufacturing the base-composition and a process of manufacturing the frozen food product utilizing said base-composition.

### BACKGROUND

Frozen food products such as ice confections, for example ice cream and the Italian counterpart named “gelato” are enjoyed due to their distinctive organoleptic properties, when frozen, of smooth creamy texture, sweet taste and rich body. These organoleptic properties are attributed mainly to the dairy components of such ice confections. However, components such as dairy are increasingly viewed as being undesirable due to their high fat content and also due to the heightened awareness of their role in causing allergic reactions.

The dairy component of an ice confection includes a “milk fat” or “butterfat” component. The inclusion of such a component increases the richness of flavour of the food product and produces a characteristic smooth texture by lubricating the palate. Also, due to its role in fat destabilization, the dairy component helps to give body to the ice confection and aids in good melting properties. There are also non-fat milk solids present in conventional ice confections i.e. lactose, caseins, whey proteins and minerals, that improve the texture of the product due to their protein functionality and help to give body and chew resistance to the finished product. They are also a cheap source of total solids.

In the current climate, much attention is directed to healthy eating and accordingly it is desirable to produce a source of healthy frozen food products whilst having all the organoleptic properties of traditional full fat ice confections. The concept of “healthy eating” not only includes being mindful of the desirability of low-fat or non-fat food products, but also being mindful of intolerances to certain types of food.

The sweetener component of traditional ice confections has also been given much attention. Ice confections such as ice cream traditionally include sucrose as the sweetener component. However, this component is commonly being limited in modern food products due to the rapidity with which sucrose raises levels of blood glucose and the related health problems associated with people suffering from defects in glucose metabolism, such as persons with hypoglycaemia or diabetes mellitus. Artificial sweeteners have been utilised as a healthy alternative. However, they have been found to contribute increased hardness in the ice confection, making it difficult to consume immediately on removal from the excessively low temperatures of a freezer. Commonly used artificial sweeteners are Phenylalanine derivatives. Phenylalanine is a laxative and results in products with warnings of the laxative effect in cases of excessive consumption.

Previous attempts to provide healthy ice confections that are, for example, dairy-free and sucrose-free have resulted in the production of soy-based ice cream. However, such a product usually contains gluten, which is now considered to be a fairly common allergen. It also leaves an after-taste of soy, even when flavoured. Such a soy-based ice cream contains on average only 15% less calories than a traditional ice cream.

### SUMMARY

It is desirable to produce a healthy frozen food product, such as an ice confection, which still possesses the distinctive organoleptic properties of traditional ice confections such as ice cream.

In respect of the present invention it has surprisingly been found that a specific combination of components contributes to the manufacture of a frozen food product having all the desirable organoleptic properties of a traditional ice confection such as ice cream or gelato, and with the advantage of not relying on the dairy components or sucrose components to confer the desirable organoleptic characteristics to the frozen food product.

In a first aspect the present invention provides a base composition for a frozen food product comprising at least one insoluble fiber, at least one soluble fiber, at least one emulsifier and at least one stabiliser.

The base composition can be used to create a frozen food product. This will usually involve further processing, via for example, dilution with water, addition of any desirable flavours, physical processing, etc. The nature of the further processing will depend on the required characteristics of the final product.

In one embodiment, the base described above further comprises at least one sweetener.

The base composition of the invention defined above does not rely on dairy derived products and sucrose to confer organoleptic properties to the final frozen food product, although it is envisaged that these components may be added for other reasons.

In one embodiment of the invention, the base described above substantially excludes milk and milk derivatives, and/or sucrose.

In a further aspect, the present invention also provides a frozen food product comprising said base as described above, water and a flavour component.

In an even further aspect, the present invention also provides a method of manufacturing a base composition for a frozen food product comprising combining at least one insoluble fiber, at least one soluble fiber, at least one emulsifier and at least one stabilizer.

In an even further aspect, it also provides a method of manufacturing a frozen food product comprising combining said components of the base composition as described above, and water, followed by further processing. In a preferred embodiment, the frozen food product is an ice confection.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

The present invention relates to a composition forming the base of a frozen food product. The base composition can be processed and flavours can be added to manufacture a frozen food product.

The base composition comprises at least one insoluble fiber, at least one soluble fiber, at least one emulsifier and at least one stabiliser.

### Insoluble Fiber

Insoluble fiber is a subclass of dietary fiber which may be derived from vegetable, fruit and/or grain, and which includes lignins, cellulose and hemicellulose. All these compounds form the structural parts of plants and do not dissolve in water.

Preferred insoluble fibers for use in the present invention include insoluble fibers derived from carrot, pea, potato, citrus, oat, apple and the like. Mixtures of one or more of these insoluble fibers are included in the scope of the invention. Also included are insoluble fibers and mixtures thereof that perform the same function and with similar results to the insoluble fibers listed above.

Embodiments of the invention that are gluten free will require selection of gluten-free insoluble fibers from the fibers described above.

One of the functions performed by insoluble fibers in a frozen food product is to protect the product from the acid present in any of the other components in the frozen food product. For example, if the frozen food product is a fruit flavoured ice cream, then the insoluble fiber acts to protect the food product from the acid in the fruit. Accordingly, any insoluble fiber that acts in a similar manner and contributes organoleptic properties to the frozen food product is included within the scope of the invention. The contribution to the organoleptic properties of the frozen food product may be a result of a combination of the insoluble fiber source with one or more of the other components in the base composition and/or the resultant frozen food product. Any other insoluble fiber expected to perform similarly, particularly as taught by the insoluble fibers listed above are also included within the scope of the invention.

The insoluble fiber(s) are generally present in the base composition in an amount of up to about 10%, preferably up to about 5% of the total weight of the base composition.

### Soluble Fiber

Soluble fibers are a subclass of dietary fibers and may be derived from vegetable, fruit and/or grain. They include compounds that dissolve or swell in water and include pectins, gums, mucilage and some hemicelluloses. These compounds are found inside and around plant cells and exist as gum arabic, guar gum, locust bean gum and pectins.

Preferred soluble fibers for use in the base composition of the present invention have been found to include inulin-type fructans. These are soluble fibers derived from chicory, artichoke, leek, onion, asparagus, wheat, barley, rye, corn, garlic, bananas, and the like. Soluble fibers for use in the base composition of the present invention also include chemical (enzymatic) fibers such as fructo-oligosaccharides (FOS) and the like. Mixtures of one or more of these soluble fibers and fibers that perform similarly are included in the scope of the invention.

Embodiments that are gluten free will require selection of gluten-free soluble fibers from the soluble fibers described above.

One of the functions performed by the soluble fiber is to provide a smooth structure to the frozen food product. Accordingly, any soluble fiber that acts in a similar manner and thereby contributes organoleptic properties to the frozen food product is included within the scope of the invention. The contribution to the organoleptic properties of the frozen food product may be a result of a combination of the soluble fiber source with one or more of the other components in the base composition and/or the resultant frozen food product. Any other soluble fiber expected to perform similarly, particularly as taught by the soluble fibers listed above are also included within the scope of the invention.

The soluble fiber is present in the base composition in an amount up to about 99%, preferably up to about 97%, more preferably up to about 95%, most preferably up to about 85% of the total weight of the base composition.

### Emulsifier

The emulsifier component of the base composition assists in preventing the final frozen food product from becoming hard and icy and assists in maintaining a smooth creamy texture over time. The emulsifier also provides support for the soluble fiber component of the final frozen food product.

Preferred emulsifiers are derived from vegetable fats. These have been found to include mono- and di-glycerides of fatty acids; acetic acid esters thereof; mono and/or diacetyl tartaric acid esters thereof; sucrose esters of fatty acids; soy lecithin; sucroglycerides; propane 1,2-diol esters of fatty acids and/or propylene glycol esters of fatty acids. The emulsifiers are commonly known as E322, E471, E472a, E472e, E473, E474 and E477. Mixtures of one or more of these emulsifiers are included within the scope of the invention.

Embodiments that are soy-free and/or gluten-free will require selection of soy-free and/or gluten-free emulsifiers from the emulsifiers described above.

Any emulsifier that acts in a similar manner and also contributes to the organoleptic properties of the frozen food product is included within the scope of the invention. The contribution to the organoleptic properties of the frozen food product may be a result of a combination of the emulsifier with one or more of the other components in the base composition and/or the resultant frozen food product. Any other emulsifier expected to perform similarly, particularly as taught by the emulsifiers listed above are also included within the scope of the invention.

The emulsifier(s) are generally present in the base composition in an amount of up to about 15%, preferably up to about 10% of the total weight of the base composition.

### Stablisier

The stabiliser is responsible for adding viscosity to the mix and the unfrozen phase of the food product. It extends the shelf life of the frozen food product by limiting ice recrystallization. It delays the crystallization of water, during storage. In the absence of stabilizers, frozen food products would become icy and coarse very quickly. Accordingly, it is desirable to utilise stabilisers in frozen food products that are to be stored for future use.

Preferred stabilisers for use in the base composition, or in addition to the base composition in the manufacture of the frozen food product, have been found to include polysaccharide food gums. These can include locust bean gum, quar gum, acacia gum, xanthan gum, carrageenan, sodium alginate, propane 1,2-diol alginate, pectins, cellulose, methyl cellulose, sodium carboxy methyl cellulose and the like. The stabilisers are commonly known as E401, E405, E407, E410, E412, E414, E415, E440, E460, E461 and E466. Mixtures of one or more of the above stabilisers are included in the scope of the invention.

Embodiments that are gluten free will require selection of gluten-free stabilisers from the stabilisers described above.

Any stabiliser that acts in a similar manner to that described above and also contributes to the organoleptic properties of the frozen food product is included within the scope of the invention. The contribution to the organoleptic properties of the frozen food product may be a result of a combination of the stabiliser with one or more of the other components in the base composition and/or the resultant frozen food product. Any other stabiliser expected to perform similarly, particularly as taught by the stabilisers listed above are also included within the scope of the invention.

The stabiliser is present in the base composition in an amount up to about 10%, preferably up to about 8% of the total weight of the base composition.

### Sweetener

A sweetener component is suitable for frozen food products that are desert-like, for example ice cream, gelato and the like. The sweetener component may also be included in the base composition in the manufacture of other types of frozen food products, not necessarily desert-like products.

A sweetener is included in amounts that depend on the nature of the frozen food product being manufactured. In one embodiment of the invention the preferred sweetener is fructose. Fructose is a simple sugar, a monosaccharide, and is present in, for example, honey, tree fruits, berries, melons and some root vegetables, for example, beets, sweet potatoes, parsnips and onions. Other sweeteners may be included in the present invention as long as they do not impact negatively on the organoleptic characteristics of the frozen food product.

In one or more embodiments of the invention, the sweetener is present in the base composition in an amount up to about 40%, preferably up to about 20%, more preferably in the range of 5% to 15% of the total weight of the base composition.

Additional sweetener may be added in the processing of the base composition to form the frozen food product. For example, additional amounts of fructose may be added to a base composition in the manufacture of a fruit ice confection, depending on the level of fructose already present in the specific fruit source utilised to make the ice confection.

In one or more embodiments, the manufacture of the base composition comprises combining each component of the base composition in any of the amounts defined above.

### Frozen Food Product

The term “frozen food product” is used in its most general sense to describe frozen or semi-frozen food products. These can include ice confections such as frozen deserts, ice cream, gelato, mousse and the like. It can also include food products that are savoury, not sweet, for example vegetable mousse, and the like.

### Base Composition

The interaction of one or more of the components of the base composition can contribute to the organoleptic properties of the frozen food product. The relative amounts of the components can also impact on the organoleptic properties.

In one or more embodiments, the ratio of soluble fiber to insoluble fiber in the base composition is in the range of 20:1 to 100:1, preferably in the range of 30:1 to about 90:1.

In one or more embodiments, the ratio of insoluble fiber to emulsifier in the base composition is in the range of 1:1 to 1:10.

In one or more embodiments, the ratio of soluble fiber to emulsifier in the base composition is in the range of 5:1 to 30:1.

In one or more embodiments, the ratio of insoluble fiber to stabiliser in the base composition is in the range of 1:1 to 1:5.

In one or more embodiments, the ratio of soluble fiber to stabiliser in the base composition is in the range of 10:1 to 100:1, preferably in the range of 10:1 to 50:1.

In one or more embodiments, the ratio of emulsifier to stabiliser in the base composition is in the range of 3:1 to 1:3.

The manufacture of the base composition comprises combining amounts of each component of the base composition within the ratios defined above in each of the above embodiments and within the ratios defined in the further embodiments below.

It is envisaged that the amounts of the components of the base composition provided above may vary due to variation in the desired taste as well as variation in source product.

The soluble and insoluble fiber(s) emulsifier(s) and stabiliser(s) of the present invention are commercially available. In one or more embodiments, the powdered form of these components are combined in the manufacture of the base composition.

### Fruit and Non-Fruit Flavoured Embodiments

The frozen food product can be savoury or sweet. In one embodiment the base composition is used to make an ice confection such as an ice cream. In this embodiment, the base composition will differ depending on the type of flavouring of the ice confection.

In one embodiment of a fruit flavoured ice confection, the base composition comprises:
a) insoluble fiber in an amount up to about 10%, preferably up to about 5%, more preferably in the range of 0.5 to 3% of the total weight of the base composition,
b) soluble fiber in an amount up to 95%, preferably in the range of 75% to 90%, more preferably in the range of 80% to 85% of the total weight of the base composition,
c) fructose in an amount up to about 40%, preferably up to about 20%, further preferably in the range of 5% to 15% of the total weight of the base composition,
d) emulsifier in an amount up to about 15%, preferably in the range of 2% to 10% of the total weight of the base composition,
e) stabiliser in an amount up to about 10%, preferably in the range of 2 to 8% of the total weight of the base composition,
f) flavourings and water can be added in an amount of up to about 10%, preferably in the range of 2% to 6% of the total weight of the base composition, and/or
g) colours and/or aromas as required.

The embodiment above is an example that can be classified as fat-free and low-in-calories. Other embodiments of the invention can be classified accordingly.

In one embodiment of a non-fruit flavoured ice confection, the base composition comprises:
a) insoluble fiber in an amount up to about 10%, preferably up to about 5%, more preferably in the range of 0.5 to 3% of the total weight of the base composition,
b) soluble fiber in an amount up to 85%, preferably between about 65% to 85%, more preferably in the range of 75% to 80% of the total weight of the base composition,
c) fructose in an amount up to about 40%, preferably up to about 20%, more preferably in the range of 5% to 15% of the total weight of the base composition,
d) emulsifier in an amount up to about 15%, preferably in the range of 5% to 10% of the total weight of the base composition,
e) stabiliser in an amount up to about 10%, preferably in the range of 0.5 to 5% of the total weight of the base composition.
f) flavourings and water can be added in an amount up to about 10%, preferably in the range of 2% to 6%, and/or
g) colours and/or aromas as required.

The embodiment above is an example that can be classified as low-in-fat and low-in-calories. Other embodiments of the invention can be classified accordingly.

Embodiments of the invention, for example as described above, can offer many advantages. These advantages relate to a base composition that can be used to manufacture a frozen food product that excludes one or more of the following components:
milk and/or milk derivatives,
gluten and/or gluten derivatives,
cereals with gluten and/or gluten derivatives,
shellfish and/or shellfish products,
egg and egg-based products,
peanuts and/or peanut based products,
soy and/or soy-based products,
milk and/or milk-based products, for example lactose,
nuts and/or nut-based products, for example hazelnuts, pistachio, almond, walnuts, unless the embodiment is a nut flavoured frozen food product, for example hazelnut ice cream,
celery and/or celery-based products,
mustard and/or mustard-based products,
sesame and/or sesame-based products, and/or
sulphur dioxide.

Some embodiments, for example nut flavours, as mentioned above, may include one or more of the above.

A further aspect of the present invention includes a method of manufacturing a frozen food product comprising combining said components of the base composition and water as required, followed by further processing. The nature of the further processing is dependent on the required characteristics of the resultant frozen food product. For example, if the frozen food product being manufactured is an ice confection such as an ice cream, the steps of homogenisation and pasteurisation would be included. Further components are added based on the characteristics of the frozen food product. If a fruit flavoured ice confection is being manufactured, fruit or fruit flavouring is added. Depending on the type of flavour anticipated, and depending on the amount of sweetener present in the flavour component, additional sweetener may be required to be added. For example, further fructose may be added to the base composition in the manufacture of a fruit flavoured ice cream. This can be seen in the examples below.

In the embodiment in which the frozen food product is an ice confection, such as an ice cream, it is preferred to maintain the solids content of the frozen food product in the range of 20% to 40%, preferably in the range of 25% to 35%, more preferably in the range of 28% to 32% of the total weight of the frozen food product. In this embodiment, or a further embodiment, it is preferred to maintain the sweetener content, i.e. total sugar content in the range of 15% to 35%, preferably 18% to about 25%, more preferably in the range of 19% to 24% of the total weight of the frozen food product.

### EXAMPLES

The invention will now be illustrated by the following non-limiting examples:

Examples 1 and 2 relate to fruit flavoured ice cream.

### Example 1

### Banana Flavoured Ice Cream:

Stage 1: The manufacture of a fruit flavoured ice cream such as banana flavoured ice cream involved 2 stages. In stage 1, a syrup was created. The syrup contained 11.2% base composition, 60% water and 28.8% fructose.

The syrup was pasteurised and homogenised in this stage.

Stage 2: The syrup is then combined with other components as follows:

| | |
|---|---|
| 1. Syrup | 560 g |
| 2. Water | 140 g |
| 3. Fructose | — |
| 4. Banana | 300 g |
| 5. Natural colour | — |
| 6. Natural aroma | — |

The combination is then processed, for example, via batch or continuous mix freezer machinery to create a banana flavoured ice cream.

### Example 2

### Cantelope Flavoured Ice Cream:

Stage 1: The manufacture of a fruit flavoured ice cream such as cantelope flavoured ice cream involved 2 stages. In stage 1, a syrup was created. The syrup contained 11.2% base composition, 60% water and 28.8% fructose.

The syrup is pasteurised and homogenised in this stage.

Stage 2: The syrup is then combined with other components as follows:

| | |
|---|---|
| 1. Syrup | 585 g |
| 2. Water | — |
| 3. Fructose | 24 g |
| 4. Banana | 387 g |
| 5. Natural colour | 2 g |
| 6. Natural aroma | 2 g |

The combination is then processed, for example, via batch or continuous mix freezer machinery to create a cantelope flavoured ice cream.

Examples 3 and 4 relate to a non-fruit ice cream:

### Example 3

### Chocolate Flavoured Ice Cream:

The following components are combined in the percentages below.

| | |
|---|---|
| 1. Base composition | 70 g |
| 2. Water | 645 g |
| 3. Cocoa | 75 g |
| 4. Fructose | 210 g |

The combination is then homogenised and pasteurised and processed in the usual manner to create chocolate flavoured ice cream.

### Example 4

### Vanilla Flavoured Ice Cream.

The following components are combined in the percentages below.

| | |
|---|---|
| 1. Base composition | 70 g |
| 2. Water | 690 g |
| 3. Fructose | 170 g |

The combination above is pasteurised and homogenised, followed by addition of the following:

| | |
|---|---|
| 4. Vanilla flavours | 50 g |
| 5. Colour and aromas | 20 g |

The resultant combination is then processed, for example, via batch or continuous mix freezer machinery to create a vanilla flavoured ice cream.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Thus, for claims defining the presence of an integer within a range or at a given amount or level, the term comprising should not be interpreted as suggesting that there may be a greater amount or level of that integer.

It will be apparent to the person skilled in the art that while the invention has been described in some detail for the purposes of clarity and understanding, various modifications and alterations to the embodiments and methods described herein may be made without departing from the scope of the inventive concept disclosed in this specification.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

What is claimed is:

1. A base composition for a frozen food product comprising at least one insoluble fiber, at least one soluble fiber, at least one emulsifier and at least one stabiliser.

2. The base composition according to claim 1, wherein the insoluble fiber(s) and/or soluble fiber(s) are dietary fibers.

3. The base composition according to claim 2, wherein the dietary fibers are derived from vegetable, fruit and/or grain.

4. The base composition according to claim 1, wherein the insoluble fiber(s) and/or soluble fiber(s) are gluten free.

5. The base composition according to claim 1, wherein the insoluble fiber(s) are selected from one or more of the group consisting of lignins, cellulose and hemicellulose.

6. The base composition according to claim 1, wherein the insoluble fiber(s) are derived from one or more of the group consisting of carrot, pea, potato, citrus, oat and apple.

7. The base composition according to claim 1, wherein the insoluble fiber(s) are present in an amount up to about 10% or up to about 5% of the total weight of the base composition.

8. The base composition according to claim 1, wherein the soluble fiber(s) are selected from one or more of the group consisting of pectins, gums, mucilage, hemicellulose, fructo-oligosaccharides and/or inulin-type fructons.

9. The base composition according to claim 1, wherein the soluble fiber(s) are derived from one or more of the group consisting of chicory, artichoke, leek, onion, asparagus, wheat, barley, rye, corn, garlic and bananas.

10. The base composition according to claim 1, wherein the soluble fiber(s) are present in an amount up to about 99%, up to about 97%, up to about 95% or up to about 85% of the total weight of the base composition.

11. The base composition according to claim 1, wherein the emulsifier(s) are derived from vegetable fats.

12. The base composition according to claim 1, wherein the emulsifier(s) are derived from one or more of the group consisting of mono- and di-glycerides of fatty acids, acetic acid esters thereof, mono and/or diacetyl tartaric acid esters thereof; sucrose esters of fatty acids; propane 1,2-diol esters of fatty acids, propylene glycol esters of fatty acids; soy lecithin and/or sucroglycerides.

13. The base composition according to claim 1, wherein the emulsifier(s) are present in an amount up to about 15% or up to about 10% of the total weight of the base composition.

14. The base composition according to claim 1, wherein the stabiliser(s) are derived from polysaccharide food gums.

15. The base composition according to claim 1, wherein the stabiliser(s) are selected from one or more of the group consisting of locust bean gum, quar gum, acacia gum, xanthan gum, carrageenan, sodium alginate, propane 1,2-diol alginate, pectins, cellulose, methyl cellulose, sodium carboxy methyl cellulose and the like.

16. The base composition according to claim 1, wherein the stabiliser(s) are present in the base composition in an amount up to about 10% or up to about 8% of the total weight of the base composition.

17. The base composition according to claim 1, further comprising a sweetener.

18. The base composition according to claim 17, wherein the sweetener comprises fructose.

19. The base composition according to claim 17, wherein the sweetener is derived from honey, tree fruits and/or root vegetables.

20. The base composition according to claim 17, wherein the sweetener is present in an amount up to about 40%, up to about 20% or in the range of 5% to 15% of the total weight of the base composition.

21. A method of manufacturing a base composition according to claim 1, comprising combining at least one insoluble fiber, at least one soluble fiber, at least one emulsifier and at least one stabiliser.

22. The method according to claim 21, wherein the insoluble fiber, soluble fiber, emulsifier and stabiliser are in powdered form.

23. A frozen food product comprising a base composition as defined in claim 1, water and a flavour component.

24. The frozen food product according to claim 23, wherein the solids content of the frozen food product is in the range of 20% to 40% of the total weight of the frozen food product.

25. A frozen food product comprising a base composition as defined in claim 1, a sweetener, water and a flavour component.

26. The frozen food product according to claim 25, wherein the solids content of the frozen food product is in the range of 20% to 40% of the total weight of the frozen food product.

27. The frozen food product according to claim 23, wherein the product is an ice confection.

28. The frozen food product according to claim 23, wherein the fruit flavoured ice confection comprises:
insoluble fiber in an amount up to about 10%, up to about 5% or in the range of 0.5 to 3.0% of the total weight of the base composition,
soluble fiber in an amount up to about 95%, in the range of 75% to 90% or in the range of 80% to 85% of the total weight of the base composition,
sweetener in an amount up to about 40%, up to about 20% or in the range of 5% to 15% of the total weight of the base composition,
emulsifier in an amount up to about 15% or in the range of 2% to 10% of the total weight of the base composition,
stabiliser in an amount up to about 10% or in the range of 2% to 8% of the total weight of the base composition,
flavourings and water in an amount of up to about 10% or in the range of 2% to 6% of the total weight of the base composition, and
optionally colours and/or aromas.

29. The frozen food product according to claim 23, wherein the non-fruit flavoured ice confection comprises:
insoluble fiber in an amount up to about 10%, up to about 5% or in the range of 0.5 to 3.0% of the total weight of the base composition,
soluble fiber in an amount up to 85%, in the range of 65% to 85% or in the range of 75% to 80% of the total weight of the base composition,
sweetener in an amount up to about 40%, up to about 20% or in the range of 5% to 15% of the total weight of the base composition,
emulsifier in an amount up to about 15% or in the range of 5% to 10%, of the total weight of the base composition,
stabiliser in an amount up to about 10% or in the range of 0.5% to 5% of the total weight of the base composition,
flavourings and water in an amount up to about 10% or in the range of 2% to 6% and
optionally colours and/or aromas.

30. A method of manufacturing a frozen food product according to claim 23, comprising the steps of combining:
at least one insoluble fiber,
at least one soluble fiber,
at least one emulsifier,
at least one stabilizer,
flavouring water and
optionally colour(s) and/or aromas.
